(19) United States
(12) Patent Application Publication
(10) Pub. No.: US 2024/0095657 A1
(43) Pub. Date: Mar. 21, 2024

(54) SYSTEM AND METHOD FOR AUTONOMOUS VEHICLE DRIVE-THROUGH DELIVERY

(71) Applicant: Ford Global Technologies, LLC, Dearborn, MI (US)

(72) Inventors: Shenglong GAO, Miami, FL (US); Travis FEUERBACHER, Los Gatos, CA (US); Jessica A. SOLOMON, San Francisco, CA (US)

(21) Appl. No.: 18/464,826

(22) Filed: Sep. 11, 2023

Related U.S. Application Data
(60) Provisional application No. 63/407,230, filed on Sep. 16, 2022.

(51) Int. Cl. G06Q 10/0835; B60R 25/01; B60R 25/23; B60W 60/00

(52) U.S. Cl. CPC G06Q 10/08355; B60R 25/01; B60R 25/23; B60W 60/00256; B60W 2556/50

(57) ABSTRACT

An autonomous vehicle (AV) includes a cabin having a receiving with a table, one or more processors, and a memory storing instructions executable by the processors. The instructions have the processors: obtain information regarding an order to be delivered from an AV delivery service system that is remote from the AV; have the navigation system set a first selected destination as a pick-up location and a second selected destination as a delivery location; provide access to the receiving area via an access panel to obtain a delivery bin when the AV is at the pick-up location; determine that the delivery bin is received for the order to cause the drive system drive to the delivery location; and instruct an access panel to be unlocked to provide access to the receiving area in response to obtaining a vehicle access code.

### CROSS-REFERENCE TO RELATED APPLICATIONS

This application claims the benefit of U.S. provisional application Ser. No. 63/407,230 filed Sep. 16, 2022, the disclosure of which is hereby incorporated in its entirety by reference herein.

### TECHNICAL FIELD

The present disclosure related to systems and/or methods for delivering items using an autonomous vehicle.

### BACKGROUND

Delivery services generally utilize human operated vehicles to provide items from a commercial establishment to a desired delivery location. A customer may order items through a software application that directs the order to a selected delivery service. A delivery driver associated with the delivery service can elect to pick-up the item and delivery it to the delivery location.

### SUMMARY

In one form, the present disclosure is directed to an autonomous vehicle (AV) including a drive system configured to autonomously drive the AV to a selected destination, a navigation system configured to monitor location of the AV and define a route to the selected destination, a cabin, and one or more access panels. The cabin includes a receiving area having a table to support a delivery bin, and the receiving area is adapted to receive the delivery bin at the table. The one or more access panels is adapted to provide access to the receiving area of the cabin. The AV further includes one or more processors and a memory storing instructions executable by the one or more processors to have the one or more processors: obtain information regarding an order to be delivered from an AV delivery service system that is remote from the AV, wherein the information includes a pick-up location and a delivery location; have the navigation system set a first selected destination as the pick-up location and a second selected destination as the delivery location; cause the drive system to drive to the pick-up location; provide access to the receiving area via the one or more access panels to obtain a delivery bin having an item to be delivered at the delivery location when the AV is at the pick-up location; determine that the delivery bin is received for the order to cause the drive system drive to the delivery location; cause a notification to be provided to a delivery application indicating that the AV is at the delivery location, where the delivery application provided the order to the AV delivery service system; and instructing the one or more access panels to be unlocked to provide access to the receiving area in response to obtaining a vehicle access code.

In one form, the present disclosure is directed to a method for delivering an item by autonomous vehicle (AV). The method includes: obtaining, by the AV, information regarding an order from an AV delivery service system, the information including a pick-up location and a delivery location; setting, by a navigation system of the AV, a first selected destination as the pick-up location and a second selected destination as the delivery location; causing a drive system of the AV drive to the pick-up location; providing, by the AV, access to a receiving area of the AV via one or more access panels when the AV is at the pick-up location, wherein the AV includes a cabin having the receiving area; receiving, by the AV, a delivery bin at a table of the receiving area; determining, by the AV, that the delivery bin is received for the order to cause the AV to travel to the delivery location; causing, by the AV, a notification to be provided to a delivery application indicating that the AV is at the delivery location, wherein the delivery application provided the order to the AV delivery service system; and unlocking, by the AV, the one or more of the access panels to provide access to the receiving area in response to receiving a vehicle access code.

In one form, the present disclosure is directed to a non-transitory computer-readable medium comprising instructions, when executed by a controller of an autonomous vehicle (AV), cause the AV to perform operations comprising: obtaining information regarding an order to be delivered from an AV delivery service system that is remote from the AV, wherein the information includes a pick-up location and a delivery location; setting a first selected destination as the pick-up location and a second selected destination as the delivery location; having a drive system of the AV drive to the pick-up location; providing access to a receiving area of a cabin the AV via one or more access panels to obtain a delivery bin having an item to be delivered at the delivery location when the AV is at the pick-up location; determining that the delivery bin is received for the order; having the drive system of the AV drive to the delivery location; transmitting a message to the AV delivery service indicating that the AV is at the delivery location to cause an arrival notification to be provided to a delivery application; and unlocking the one or more access panels to provide access to the receiving area in response to obtaining a vehicle access code.

### BRIEF DESCRIPTION OF THE DRAWINGS

FIG. 1 illustrates an autonomous vehicle delivery system for having items delivered by an autonomous vehicle (AV) in accordance with the present disclosure;

FIG. 2 illustrates a delivery bin for delivering items in accordance with the present disclosure;

FIG. 3 illustrates an example of the AV in accordance with the present disclosure;

FIG. 4 is a block diagram of the AV delivery service system in accordance with the present disclosure;

FIG. 5 is a flowchart of an example autonomous vehicle delivery routine in accordance with the present disclosure;

FIG. 6A illustrates an example order notification in accordance with the present disclosure;

FIG. 6B illustrates an example representation of an item being placed in a delivery bin in accordance with the present disclosure;

FIG. 6C illustrates an example pick-up arrangement of the AV in accordance with the present disclosure;

FIG. 6D illustrates a table of the AV receiving one or more delivery bins in accordance with the present disclosure;

FIG. 6E illustrates an example status notification in accordance with the present disclosure;

FIG. 6F illustrates an example of a first arrival notification in accordance with the present disclosure; and

FIG. 6G illustrates an example of a second arrival notification in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

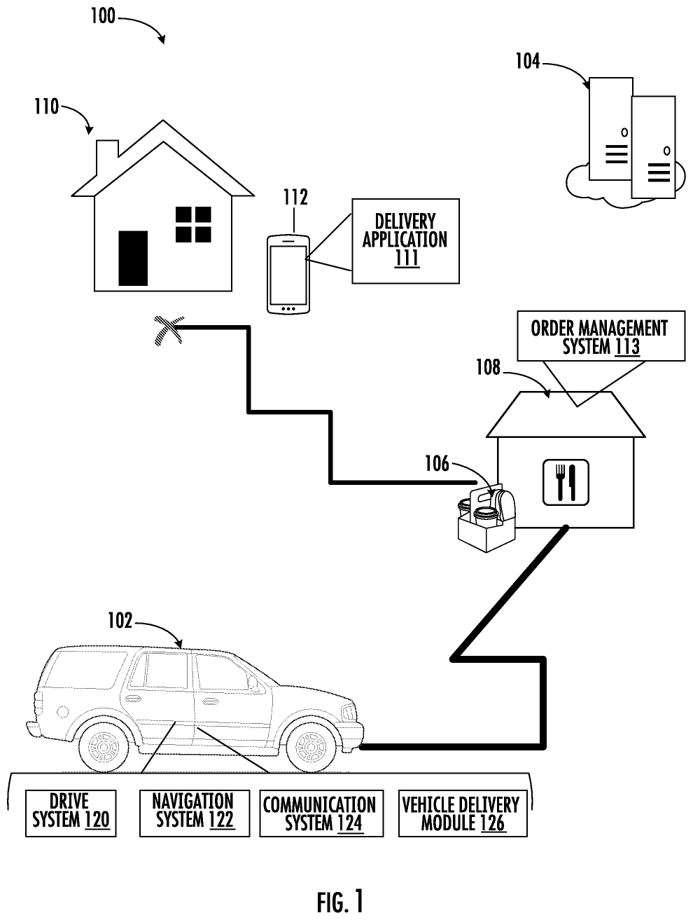

Referring to FIG. 1, an example autonomous vehicle (AV) delivery system 100 utilizes an autonomous vehicle (AV) 102 and an AV delivery service (AV-DS) system 104 for delivering one or more item 106 from a commercial establishment 108 to a selected destination 110. As detailed herein, the AV-DS system 102 is configured to obtain an order from a delivery application 111 supported by the AV-DS system 104, where the order includes information indicative of a pick-up location (e.g., commercial establishment 108), a delivery location for the order (e.g., the selected destination 110), and the items 106 to be provided by the commercial establishment 108. The commercial establishment 108 having an order management system 113 fulfils the order, and the AV 102 is configured to obtain the items 106 from the commercial establishment 108 and deliver the items to the delivery location, as the selected destination 110.

In one form, the delivery application 111 is a software program stored and executed by a computing device 112 such as, a smart phone, tablet, laptop, among other computing devices. A customer may receive updates regarding the order via the delivery application 111.

The AV-DS system 104, the AV 102, the order management system 113, and the delivery application 111 via the computing device 112 may communicate with one another via a communication platform formed of one or more wireless connections by one or more wireless networks (e.g., cellular network, Wi-Fi, satellite). Accordingly, The AV-DS system 104, the AV 102, the order management system 113, and the computing device 112 may include various communication devices and software protocols, such as but not limited to: modems, transceivers, global navigation satellite system (GNSS) receiver, and/or one or more controller configured to execute one or more communication protocols (e.g., BLUETOOTH, near-field communication (NFC), Transmission Control Protocol (TCP), cellular protocols, among others).

The order management system 113 of the commercial establishment 108 is configured receive and process orders to be delivered via the AV 102. In one form, the order management system 113 may include a server (local and/or cloud-based server) and one or more computing devices configured to interface with a user to access data/functions supported by the server. Specifically, using known techniques, the order placement system 113 receives and manages an order to be filled by the commercial establishment 108. In a non-limiting example, the order management system 113 may receive the order through a website associated with the commercial establishment 108, a dedicated software application associated with the commercial establishment 108 including the delivery application 111 as a delivery option, and/or a third party application associated with the AV-DS system 104. In one form, the order management system 113 is configured to accept the order, refuse the order, and/or provide status of the order to the AV-DS system. In a non-limiting example, the order management system 113 is configured to receive inputs regarding the status of the order from one or more employees of the commercial establishment via the computing device provided in the commercial establishment 108, and the order management system 113 transmits messages to the AV-DS system 104 regarding the order.

In a non-limiting example, the commercial establishment 108 is a pharmacy, restaurant (e.g., fast food, café, sit-down restaurant); a grocery store, and/or a retail business. In one form, the commercial establishment, as a pick-up location of the order, has a designated area for the AV to obtain the items 106, such as, but not limited to: drive-through window, one or more parking spaces, and/or a docking area.

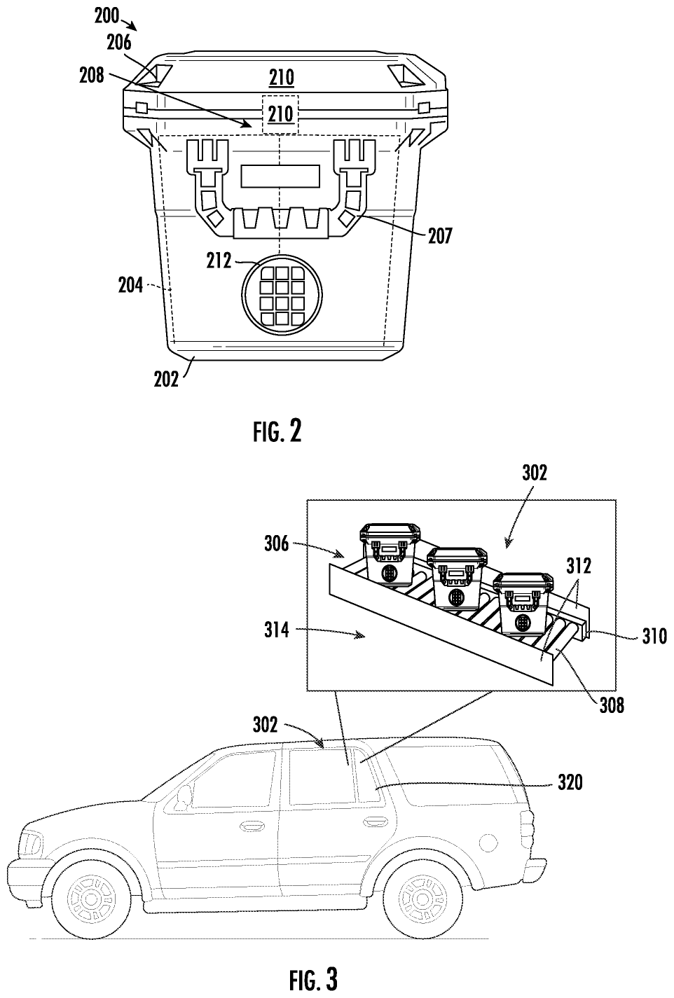

In one form, the items 106 for the order are placed in a delivery bin. In a non-limiting example, referring to FIG. 2, a delivery bin 200 is employed to hold the items 106, and includes a container 202 defining a chamber 204, a lid 206 arranged to cover/uncover the chamber 204, and at least one pair of handles 207 arranged on opposites sides of the container 202. In one form, the container 202 has a hard exterior with a weighted bottom, and is insulated for temperature control. The delivery bin 200 may come in different shape(s) and size(s), and should not be limited to the configuration provided in the figures.

In one form, the delivery bin 200 further includes a locking device 208 to inhibit removal of the items 106 from bin 200 by an unauthorized person. In a non-limiting example, the locking device 208 includes a lock 210 operable to fasten/unfasten the lid 206 to/from the container 202, and an input interface 212, such as, a keypad, to operate the lock 208 by entering a unique code. The locking device 208 having the lock 210 and the input interface 212 is reprogrammable, and may be an electronic locking device and/or electromechanical locking device. More particularly, as described herein, the customer is provided with an access code inputted via the input interface 212 to have the locking device 208 unfasten to permit access to the chamber 204. In one form, the access code is reprogrammable by the AV-DS system 104 and/or by the order management system 113.

Other types of locking devices 208 may be employed. For example, the input interface 212 may be provided as a short-range communication device that unlocks the lock 210 upon receiving a wireless signal having a unique code from, for example, the computing device 112. The short range communication device may employ BLUETOOTH, NFC, and/or other suitable secure short range communication protocols.

Each delivery bin 200 may also be associated with a unique identifier (e.g., an alpha-numeric character string, or an image). In one form, the order management system 113 is configured to track or monitor the use of each delivery bin 200. In a non-limiting example, the order management system 113 stores information indicative of the unique identifier and associates the unique identifier with information related to the bin 200, such as but not limited to: bin information (e.g., size, maker, capacity, color, among other properties of the bin); a status of the delivery bin 200 (e.g., out for delivery, in storage area of commercial establishment, out for maintenance/cleaning, among other statuses); if applicable, information related current order the bin 200 is being employed for (e.g., an access code currently associated with the delivery bin 200, the delivery location, items provided in the bin 200, or an order number), and/or information related to previous orders (e.g., order number, date). In some variations, the information related to each delivery bin 200 is stored by other systems, such as but not limited to, the AV-DS system 104 and/or a third-party supplier employed to provide the delivery bin 200 to the commercial establishment 108.

With continuing reference to FIG. 1, the AV 102 is a fully autonomous vehicle or self-driving vehicle configured to travel to a selected destination, such as the pick-up location and the delivery location. While one AV 102 is illustrated, a plurality of AVs 102 may be used and provided as a delivery fleet, and the AV-DS system 104 is configured to select an AV 102 from among member of the delivery fleet.

In one form, among other components and vehicle systems, the AV 102 includes a drive system 120, a navigation system 122, a communication system 124, and a vehicle delivery module 126. The drive system 120 is configured to control movement or, in other words, drive of the AV 102 to the selected destination. In a non-limiting example, the drive system includes a drivetrain, a transmission system, a steering system, and/or a brake system.

The navigation system 122 is configured to monitor location of the AV 102 and define a route to the selected destination. In one form, the navigation system 122 may include a GNSS receiver, maps, and a route planning controller configured to define a route to the selected destination using known techniques.

The communication system 124 is configured to exchange information with external devices/system, and support communication among devices/vehicle systems within the AV. Accordingly, the communication system 124 may include a vehicle network (e.g., control area network), a telematics control unit (TCU), a modem, transceiver, GNSS, and/or a controller configured to execute one or more communication protocols (e.g., BLUETOOTH, TCP, cellular protocols).

The vehicle delivery module 126 is configured to control the AV 102 to deliver the delivery bin 200 to the delivery location. In a non-limiting example, the vehicle delivery module 126 is configured to receive or obtain a notification from the AV-DS system 102 indicating information related to the order, such as, but not limited to the pick-up location and the delivery notification.

The vehicle delivery module 126 has the AV 102 travel to the pick-up location via the navigation system 122 and the drive system 120. In a non-limiting example, the module 126 has the navigation system 122 set a first selected destination as the pick-up location and a second selected destination as the delivery location. The navigation system 122 then define one or more routes for traveling to the selected destinations. Using the routes defined, the drive system 120 drive to the pick-up location.

Once at the pick-up location and more specifically, at a designated area of the pick-up location, the vehicle delivery module 126 aligns the AV 102 with the designated area and provides access to the interior of the AV 102 via an access panel (e.g., lowers a window or unlocks a door). In one form, the vehicle delivery module 126 is configured to monitor the delivery bin 200. In a non-limiting example, using images of the interior of the AV 102 and known object detection techniques, the vehicle delivery module 126 may detect when the delivery bin 200 is received at the pick-up location, remove from the AV 102 at the delivery location, and/or returned to the AV 102. Employing a digital key system, the vehicle delivery module 126 is further configured to unlock one or more doors of the AV 102 (i.e., the access panels include door) when a vehicle access key/code is received.

In one form, the vehicle delivery module 126 is configured to provide a status update of the delivery to the AV-DS system 104, which may in return transmit notifications to the delivery application 111. In a non-limiting example, the vehicle delivery module 126 may notify the AV-DS system 104 when the delivery bin(s) is 200 are received, when the AV 102 is at the delivery location, when the delivery bins(s) 200 is removed and/or returned at the delivery location, and/or when the delivery is complete.

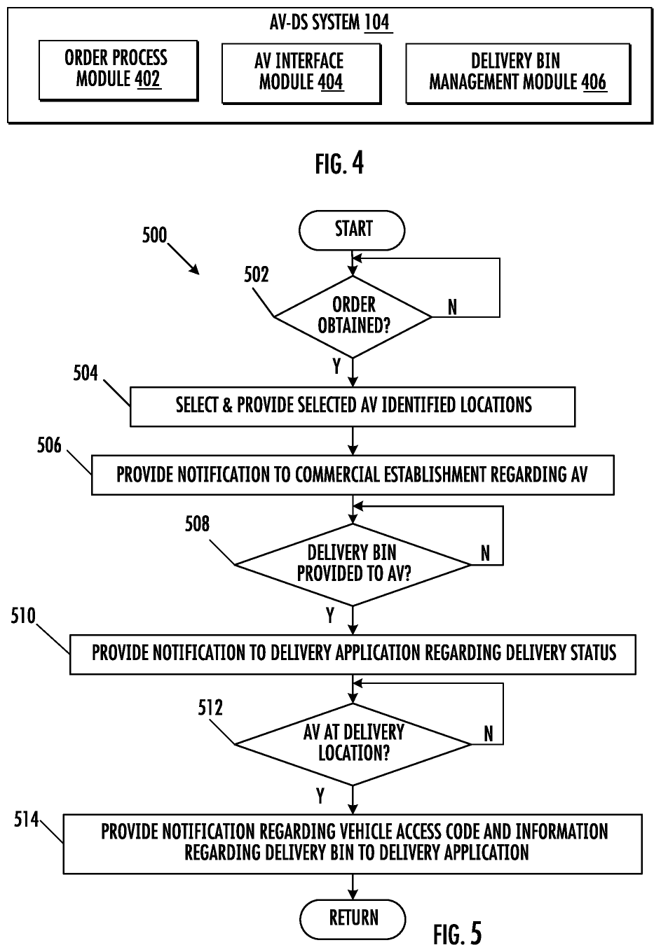

In addition to the vehicle systems, the AV 102 is adapted to receive one or more of the delivery bins 200. More particularly, referring to FIG. 3, the AV 102 includes a cabin 302 having a receiving area 304, and a table 306 arranged in the receiving area 304 of the cabin 302 to support the delivery bins 200. In one form, the table 306 is a rolling table having multiple rollers 308 arranged in parallel and attached to a frame 310 forming a planar support for receiving and supporting the bins 200. The table 306 may also include retainment walls 312 to hold or retain the delivery bins 200 on the planar support. The size and/or shape of the table 306 may be configured in various suitable way based on the size of the cabin 302, and should not be limited to the examples provided in the drawings.

In one form, the cabin 302 may also have a return area 314 to hold delivery bins 200 that are empty. In a non-limiting example, at least a portion of the return area 314 is provided under the table 306.

To obtain the delivery bin 200, the AV 102, includes an access panel 320 that provides access to the receiving area 304 of the cabin 302. In a non-limiting example, the access panel 320 is a window operable to provide access to the receiving area 304 or inhibit access to the receiving area 304. In another example, the access panel 320 may be a door of the AV 102 that is operable to open and close to provide access to the receiving area 304. Thus, the AV 102 may include one or more access panels for providing access to the cabin 302.

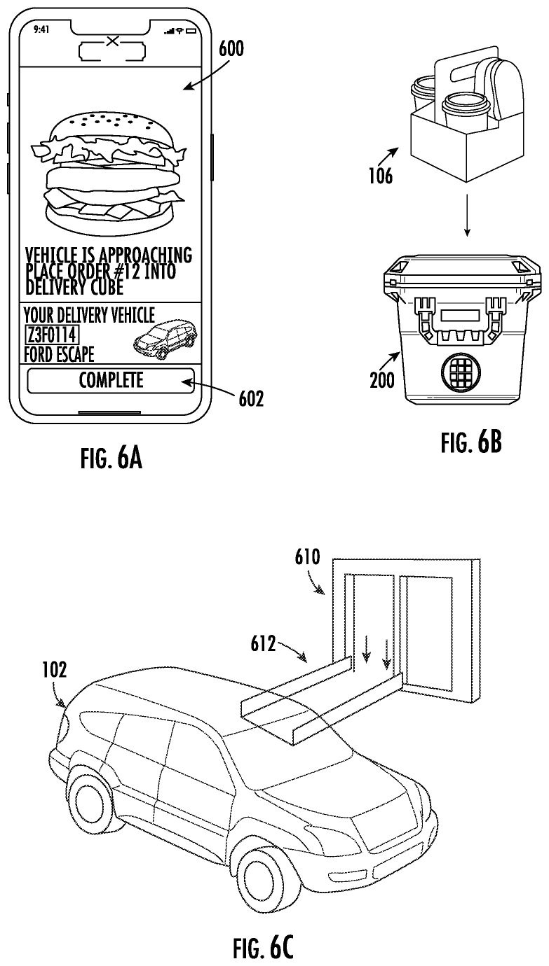

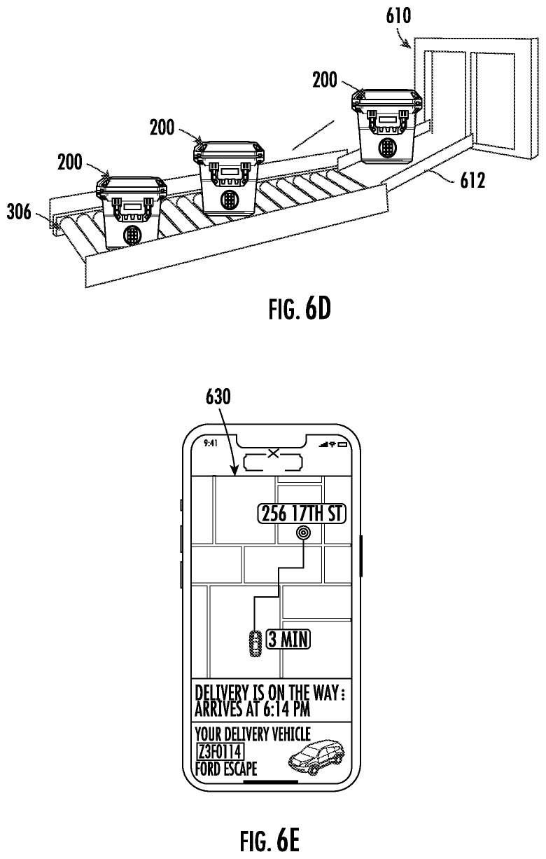

Referring to FIGS. 4 and 5, in one form, the AV-DS system 104 is a cloud-based server configured to perform the operations described herein to have the AV 102 deliver items to a delivery location. In a non-limiting example, the AV-DS system 104 includes an order process module 402, an AV interface module 404, and a delivery bin management module 406.

The order process module 402 is configured to obtain an order from the delivery application 111, where the order includes information indicating, for example, the pick-up location, the delivery location for the order, and the item to be provided by the commercial establishment 108 identified in the order. Once obtained, the order process module 402 is configured to issue one or more notifications to the delivery application 111 to provide information regarding the order to the customer as the order being processes by the system 100. In a non-limiting example, the notifications include identification information for the delivery bin, an access code for unlocking the delivery bin, and/or an arrival notice indicating the AV is at the delivery location. The notifications may request the user of the delivery application 111 to provide input, such as, but not limited to: whether the delivery bin 200 is placed back in the AV 102, whether the delivery bin contained the items ordered, and/or for a vehicle access code that is a digital key to permit access to the AV 102.

The order process module 402 is further configured to communicate with the order management system 113 of the commercial establishment 108 to check the status of the order and provide information to assist in fulfilling the order. In a non-limiting example, the order process module 402 is configured to verify whether the commercial establishment 108 is able to fulfill the order. If so, the order process module 402 obtains an estimate time of completion from the order management system 113 and receive information regarding delivery bin 200 employed to hold the items of the order, such as, but not limited to: the unique identifier of the delivery bin and the access code assigned to open the bin 200 if the order management system 113 programs the access code.

The AV interface module 404 is configured to monitor the AV(s) 102 employed to deliver items 106. The AV interface module 404 may store information related to the AV(s), such as but not limited to: unique AV identifier (e.g., license plate), make and model of the AV 102, information related to digital key used to access the AV 102, location of the AV 102, and/or availability of the AV 102.

In one form, the AV interface module 404 is configured to have the AV 102 travel to the pick-up location and the delivery location for a selected order. That is, in one form, the AV interface module 404 is configured to select an AV 102 from among members of the fleet based on: availability of the AV (i.e., are there any empty bins in the AV 102); proximity of the AV 102 to the pick-up location; and/or the estimate time of completion to prepare the order. In an example scenario, if a first AV 102 is provided closer to the pick-up location than a second AV 102 but includes multiple delivery bins 200 for one or more orders, the AV interface module 404 selects the second AV 102 if the second AV 102 has capacity to pick up the delivery bin 200. In another scenario, if the travel time to the pickup location for a first AV 102, which is available, is longer than that of a second AV that will be available after a current delivery, and the estimated time of completion of the order is longer than a travel time of the first AV 102, the AV interface module 404 is configured to select the second AV to conserve energy of the first AV 102. While specific examples are provided, the rules employed for the AV interface module 404 may be configured in various suitable ways and should not be limited to the examples provided herein.

Once selected, the AV interface module 404 is further configured to provide the selected AV 102 with the pick-up location and the delivery location, which are employed by the AV 102 to set the destination of the AV 102. The AV interface module 404 is further configured to receive status information from the AV 102. In a non-limiting example, the AV 102 may transmit location information to the AV-DS system 102, the AV 102 transmits a message when the delivery bin 200 is provided in the cabin 302, and/or the AV 102 provides a message when the delivery bin 200 is removed from and/or returned to the cabin at the delivery location.

In one form, the AV interface module 404 is further configured to instruct the AV 102 to travel to a repository to return the delivery bin(s) 200 that are empty and in the return area 314 of the cabin 302 after a selected number of deliveries are made, after a selected number of delivery bins 200 are obtained, and/or a selected time period has passed after a delivery is made, among other criteria being filled.

The delivery bin management module 406 is configured to monitor and track the delivery bin(s) 200 employed for the delivery(ies). In a non-limiting example, the delivery bin management module 406 is configured to store the unique identifier, current order the bin 200 is being employed for, the access code currently associated with the delivery bin 200, and the delivery location. In one form, the delivery bin management module 406 may also be configured to reprogram the access code for the locking device and provide the access code to the order management system 113, which then reprograms the access code using known techniques.

In lieu of human driven vehicles, the autonomous vehicle delivery system 100 of the present disclosure provides a delivery service employing AVs 102 and the AV-DS system 104. The system 100 further utilizes the delivery application 111 to communicate with the customer.

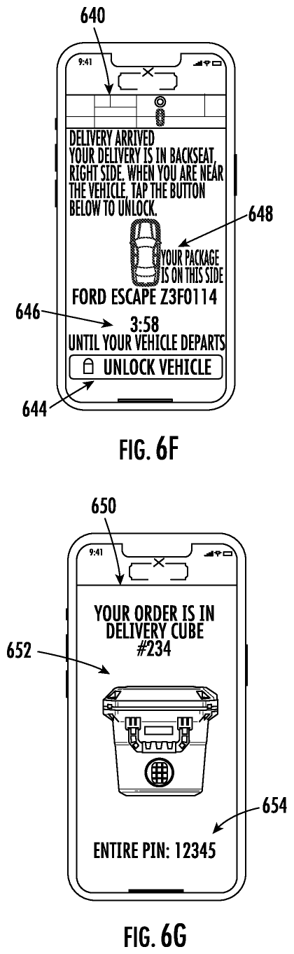

Referring to FIGS. 5 and 6A to 6G, an example operation of the system 100 is provided with FIG. 5 illustrating an autonomous vehicle delivery routine 500 that is executed by AV-DS system 104. At 502, the AV-DS system 104 determines if an order is obtained via, for example, the delivery application 111. If so, the AV-DS system 104, at 504, selects an AV 102 from among a fleet of AVs 102 and provides the selected AV 102 information regarding the order, such as, but not limited to, the pick-up location and the delivery location. At 506, the AV-DS system 104 is configured to provide a notification to the order management system 113 of the commercial establishment 108 regarding the AV 102. In a non-limiting example, FIG. 6A illustrates an order notification 600 provided to the order management system 113 at the commercial establishment 108. Along with information regarding the order (e.g., order number) and the AV 102 assigned, the notification 600 includes an order complete input interface 602 operable by an employee at the commercial establishment 108 once the delivery bin 200 is in the AV 102.

For example, once the item is prepared, it is placed in the delivery bin 200 (FIG. 6B), and the delivery bin 200 is then provided to the AV 102. Specifically, referring to FIGS. 6C and 6D, the AV 102 aligns the access panel 320 to a designated area 610 of the pick-up location, such as a drive-through window, and opens the access panel 320 to receive the delivery bin 200. In a non-limiting example, the AV 102 receives a guide ramp 612 extending to the table 306 of the cabin 302 via the access panel 320, where the delivery bin 200 is received by the table 306 via the guide ramp 612. After providing the delivery bin 200 to the AV 102, an employee (not shown) operates the order complete input interface 602 and the order management system 113 transmits a message to the AV-DS system 104 indicating that the order is placed in the AV 102.

At 508, the AV-DS system 104 is configured to determine whether the delivery bin 200 is provided to the AV 102. As detailed above, the AV-DS system 104 is configured determine that the delivery bin 200 is received based on, for example, a message from the order management system 113 and/or a message from the AV 102. If delivered, at 510, the AV-DS system 104 is configured to provide notification to the delivery application 111 regarding a status of the delivery. In a non-limiting example, FIG. 6E illustrates a status notification 630 to the delivery application 111 on the computing device 112 indicating that the AV 102 is on its way to the pick-up location with information related to the AV 102.

At 512, the AV-DS system 104 is configured to determine whether the AV 102 is at the delivery location. If so, the AV-DS system 104 is configured to notify the delivery application 111 of the AV 102 arrival, and provide the vehicle access code and information regarding the delivery bin 200 to the delivery application 111. In a non-limiting example, FIG. 6F illustrates a first arrival notification 640 that indicates the AV 102 has arrived; displays an unlock vehicle interface 644 which provides the vehicle access code to the AV 102 when operated by the user; an estimated departure time 646 of the AV 102; and a bin location 648 of the delivery bin 200 for the order. FIG. 6G is a second arrival notification 650 that provides a bin information 652 (e.g., a bin number assigned to the delivery bin 200) and an access code 654 for the delivery bin 200. While not illustrated the notification or another notification may be provided with a delivery complete interface operable by the user of the computing device 112 to indicate the delivery is complete.

Once the delivery is complete, the AV-DS system 104 instructs the AV 102 to travel to another destination such as another pick-up location or the repository for returning the delivery bin(s) 200.

It should be readily understood that FIGS. 5 and 6A to 6G is just one example of the autonomous vehicle delivery system 100 of the present disclosure, and that the operation of the autonomous vehicle delivery system may be configured in other suitable ways based on the present disclosure. In a non-limiting example, when the order is obtained, AV-DS system 104 is configured to confirm that the order can be fulfilled from the commercial establishment 108; the order may be first provided to the commercial establishment, which provides is to the AV-DS system 104 after confirming that the order may be filled; the AV 102 may detect presence and removal of the bin 200 to provide a status of the order to the AV-DS system 104.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure. Additionally, the features of various implementing embodiments may be combined to form further embodiments of the invention.

What is claimed is:

1. An autonomous vehicle (AV) comprising:
a drive system configured to autonomously drive the AV to a selected destination,
a navigation system configured to monitor location of the AV and define a route to the selected destination;
a cabin including a receiving area having a table to support a delivery bin, wherein the receiving area is configured to receive the delivery bin at the table;
one or more access panels adapted to provide access to the receiving area of the cabin;
one or more processors;
a memory storing instructions executable by the one or more processors to have the one or more processors:
obtain information regarding an order to be delivered from an AV delivery service system that is remote from the AV, wherein the information includes a pick-up location and a delivery location;
have the navigation system set a first selected destination as the pick-up location and a second selected destination as the delivery location;
cause the drive system to drive to the pick-up location;
provide access to the receiving area via the one or more access panels to obtain a delivery bin having an item to be delivered at the delivery location when the AV is at the pick-up location;
determine that the delivery bin is received for the order to cause the drive system drive to the delivery location;
cause a notification to be provided to a delivery application indicating that the AV is at the delivery location, wherein the delivery application provided the order to the AV delivery service system; and
instruct the one or more access panels to be unlocked to provide access to the receiving area in response to obtaining a vehicle access code.

2. The system of claim 1, wherein the cabin includes a return area adapted to obtain the delivery bin without the item provided therein.

3. The system of claim 2, wherein at least a portion of the return area is provided below the table of the cabin.

4. The system of claim 1, wherein the table is a rolling table.

5. The system of claim 1, wherein the cabin is adapted to receive a guide ramp extending to the table of the cabin via the access panel, wherein the delivery bin is received by the table via the guide ramp.

6. The system of claim 5, wherein at least one of the one or more access panel is a window operable to provide access to the receiving area or inhibit access to the receiving area and adapted to receive the guide ramp.

7. A system, comprising:
the AV of claim 1;
an AV delivery service system communicably coupled to the AV and the delivery application stored and executed by a computing device, the AV delivery service system comprising one or more second processors and second memory storing programming instructions that are configured to cause the one or more second processors to:
obtain the order from the delivery application, wherein the order includes information indicative of the pick-up location, the delivery location for the order, and the item to be provided by a commercial establishment;
have the AV drive to the delivery location in response to determining that the delivery bin is disposed in the AV;
issue one or more notifications to the computing device having the delivery application, the one or more notifications including at least one of identification information for the delivery bin, an access code for unlocking the delivery bin, and an arrival notice indicating the AV is at the delivery location; and
transmit the vehicle access code to the computing device in response to the AV being at the delivery location.

8. The system of claim 7, wherein the programming instructions are further configured to cause the one or more processors of the AV delivery service system to instruct the AV to travel to a repository to return the delivery bin without the item provided therein after determining that the delivery bin is complete.

9. The system of claim 7 further comprising:
one or more delivery bins, each delivery bin including:
a container defining a chamber to hold an item,
a lid arranged to cover the chamber, and
a locking device operable to fasten the lid to the container and to unfasten the lid from the container.

10. The system of claim 9, wherein:
the locking device of each delivery bin further includes an interface device,
the locking device is configured to unfasten the lid from the container in response to receiving the access code at the interface device.

11. A method for delivering an item by autonomous vehicle (AV), comprising:
obtaining, by the AV, information regarding an order from an AV delivery service system, the information including a pick-up location and a delivery location;
setting, by a navigation system of the AV, a first selected destination as the pick-up location and a second selected destination as the delivery location;
causing a drive system of the AV drive to the pick-up location;
providing, by the AV, access to a receiving area of the AV via one or more access panels when the AV is at the pick-up location, wherein the AV includes a cabin having the receiving area;
receiving, by the AV, a delivery bin at a table of the receiving area;
determining, by the AV, that the delivery bin is received for the order to cause the AV to travel to the delivery location;
causing, by the AV, a notification to be provided to a delivery application indicating that the AV is at the delivery location, wherein the delivery application provided the order to the AV delivery service system; and
unlocking, by the AV, the one or more of the access panels to provide access to the receiving area in response to receiving a vehicle access code.

12. The method of claim 11, further comprises:
obtaining, by the AV, the delivery bin without the item provided therein at a return area of the cabin of the AV; and
traveling, by the AV, to a repository to return the delivery bin without the item provided therein after determining that the delivery is completed.

13. The method of claim 12, further comprising instructing, by the AV delivery service system, the AV to travel to the repository.

14. The method of claim 12, further comprising:
issuing, by the AV delivery service system, one or more notifications to a computing device having the delivery application, the one or more notifications including at least one of identification information for the delivery bin, the access code for unlocking the delivery bin, and an arrival notice indicating the AV is at the delivery location; and
transmitting, by the AV delivery service system, the vehicle access code to the computing device in response to the AV being at the delivery location.

15. The method of claim 11, wherein the receiving, by the AV, a delivery bin at the table of the receiving area further comprises:
aligning, by the AV, at least one of the one or more access panels of the AV to a designated area at the pick-up location, the at least one access panel providing access to the receiving area of the cabin; and
receiving, by the AV, a guide ramp extending to the table of the cabin via the at least one of the one or more access panel, wherein the delivery bin is received by the table via the guide ramp.

16. The method of claim 11, wherein the delivery bin includes a locking device having an interface device, a lid, and a container defining chamber to hold the item, wherein the method further comprising unlocking, by the delivery bin, the locking device to unfasten the lid from the container in response to receiving an access code at the interface device.

17. A non-transitory computer-readable medium comprising instructions, when executed by a controller of an autonomous vehicle (AV), cause the AV to perform operations comprising:
obtaining information regarding an order to be delivered from an AV delivery service system that is remote from the AV, wherein the information includes a pick-up location and a delivery location;
setting a first selected destination as the pick-up location and a second selected destination as the delivery location;
having a drive system of the AV drive to the pick-up location;
providing access to a receiving area of a cabin the AV via one or more access panels to obtain a delivery bin having an item to be delivered at the delivery location when the AV is at the pick-up location;
determining that the delivery bin is received for the order;
having the drive system of the AV drive to the delivery location;
transmitting a message to the AV delivery service indicating that the AV is at the delivery location to cause an arrival notification to be provided to a delivery application; and
unlocking the one or more access panels to provide access to the receiving area in response to obtaining a vehicle access code.

18. The non-transitory computer-readable medium of claim 17, further comprising instructions to cause the AV to perform operations comprising:
setting a third selected destination as a repository; and
having the drive system of the AV drive to the repository to return the delivery bin without the item provided therein after determining that the delivery is complete.

19. The non-transitory computer-readable medium of claim 17, further comprising instructions to cause the AV to perform operations:
aligning at least one access panel from among the one or more access panels of the AV to a designated area at the pick-up location, the at least one access panel providing access to the receiving area of the cabin; and
controlling the at least one access panel to provide access to a table of the receiving area via a guide ramp extending into the cabin to have the table receive the delivery bin via the guide ramp.

20. The non-transitory computer-readable medium of claim 17, further comprising instructions to cause the AV to perform operations notifying the AV delivery service system of a status of the delivery including a location of the AV.
